(19) United States
(12) Patent Application Publication
(10) Pub. No.: US 2023/0334202 A1
(43) Pub. Date: Oct. 19, 2023

(54) COMPUTER-READABLE RECORDING MEDIUM STORING MACHINE LEARNING PROGRAM, MACHINE LEARNING METHOD, AND THERMAL ANALYSIS DEVICE

(71) Applicant: Fujitsu Limited, Kawasaki-shi (JP)

(72) Inventors: Hiromitsu SONEDA, Atsugi (JP); Masatoshi OGAWA, Zama (JP)

(73) Assignee: Fujitsu Limited, Kawasaki-shi (JP)

(21) Appl. No.: 18/109,283

(22) Filed: Feb. 14, 2023

(30) Foreign Application Priority Data
Apr. 13, 2022 (JP) 2022-066545

(51) Int. Cl. G06F 30/27

(52) U.S. Cl. CPC G06F 30/27; G06F 2119/08

(57) ABSTRACT

A non-transitory computer-readable recording medium storing a machine learning program for causing a computer to execute a process, the process includes obtaining training data that includes shape information of a heat sink that serves as an explanatory variable and heat distribution information of the heat sink that serves as an objective variable, and executing, based on the training data, machine learning of a machine learning model according to a loss function that includes an expression that constrains a temperature relationship of a plurality of positions in the heat sink.

### CROSS-REFERENCE TO RELATED APPLICATION

This application is based upon and claims the benefit of priority of the prior Japanese Patent Application No. 2022-066545, filed on Apr. 13, 2022, the entire contents of which are incorporated herein by reference.

### FIELD

The embodiment discussed herein is related to a machine learning technique in heat sink design.

### BACKGROUND

It is known to use thermal analysis to design heat sinks. In recent years, thermal analysis simulation using physical models or machine learning models has been used to optimize a shape of heat sinks.

Japanese Laid-open Patent Publication No. 2019-118940, Japanese Laid-open Patent Publication No. 2003-223470, and U.S. Pat. Application Publication No. 2017/0091356 are disclosed as related art.

### SUMMARY

According to an aspect of the embodiments, a non-transitory computer-readable recording medium storing a machine learning program for causing a computer to execute a process, the process includes obtaining training data that includes shape information of a heat sink that serves as an explanatory variable and heat distribution information of the heat sink that serves as an objective variable, and executing, based on the training data, machine learning of a machine learning model according to a loss function that includes an expression that constrains a temperature relationship of a plurality of positions in the heat sink.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block illustrating a functional configuration of a thermal analysis device 1 according to an embodiment;

FIG. 2 is a diagram schematically illustrating an example of input information 21a;

FIG. 3 is a diagram schematically illustrating an example of output information 21b;

FIG. 4 is a diagram schematically illustrating a machine learning method of a machine learning model MM by a machine learning unit 22;

FIG. 5 is a diagram schematically illustrating a thermal analysis method by an analysis unit 21; and

FIG. 6 is a diagram for explaining an exemplary hardware configuration.

### DESCRIPTION OF EMBODIMENTS

When a physical model is used for the thermal analysis, it is likely that a result in line with physics is obtained while there is a problem of speeding up due to a long calculation time. When a machine learning model is used, while a process may be speeded up, a result in line with physics may not be obtained and analysis accuracy may be lowered in an area with no training data.

Hereinafter, an embodiment of techniques capable of performing thermal analysis of a heat sink at high speed and with high accuracy will be described in detail with reference to the drawings. The present disclosure is not limited by the embodiment. Each mode may be appropriately combined within a consistent range.

As a pace of development of devices incorporating heat sinks is speeded up, there is a demand for thermal design to be speeded up. In recent years, with an increase in the amount of heat generation, a need to perform thermal design in advance from a very initial stage has arisen. In that case, it is useful not only to strictly estimate thermal performance for a specific model over a long period of time but also to reach an estimate in a very short period of time (a few minutes). Furthermore, it is desirable that even a person not skilled in the thermal analysis may easily estimate the thermal performance. Heat sinks are commonly individually designed for each heat generation source, such as equipment or device, and the design needs to optimize the thermal performance, size, weight, and the like in a well-balanced manner.

Thermal analysis simulation is carried out to optimize a shape of the heat sinks. A physical model or a machine learning model is used for the simulation, which has the following advantages and disadvantages. When a physical model is used, a result in line with physical phenomena is obtained while a calculation time increases to raise a problem of speeding up. Furthermore, there may be a deviation between an actually measured value and an estimated value based on the physical model. By using a machine learning model, it becomes possible to shorten the calculation time to achieve speeding up. At training data points, a deviation between an actually measured value and an estimated value based on the machine learning model is small. However, it is less reliable in estimating areas with no training data. There is no guarantee that an estimation result matches physics. For those reasons, a problem of achieving high accuracy remains.

The thermal analysis simulation needs to be speeded up and to be highly accurate to increase the development speed of heat sinks. However, the physical model or the machine learning model to be used for the simulation each have the drawbacks described above. According to the disclosed technique, it becomes possible to overcome those drawbacks to perform thermal analysis of heat sinks at high speed and with high accuracy.

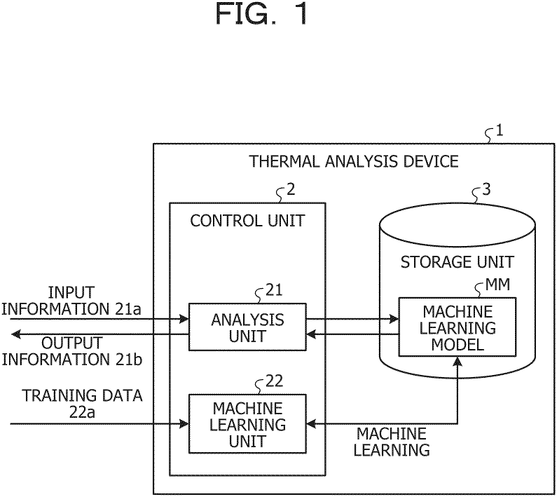

FIG. 1 is a functional block illustrating a functional configuration of a thermal analysis device 1 according to the embodiment. The thermal analysis device 1 is a device that performs thermal analysis of a heat sink. The thermal analysis device 1 includes a control unit 2 and a storage unit 3. The storage unit 3 stores various types of information needed for control by the control unit 2. FIG. 1 exemplifies a machine learning model MM among the information stored in the storage unit 3.

The control unit 2 is a processing unit that controls overall processing of the thermal analysis device 1, and includes an analysis unit 21 and a machine learning unit 22. Input information 21a is input to the analysis unit 21. The input information 21a includes heat sink shape information. The input information 21a, which may vary depending on a heat sink type or the like, is input to the analysis unit 21.

The analysis unit 21 carries out the thermal analysis based on the input information 21a, and outputs a result of the thermal analysis as output information 21b. The output information 21b includes heat distribution information of the heat sink. Various types of the output information 21b corresponding to the input information 21a are output by the analysis unit 21.

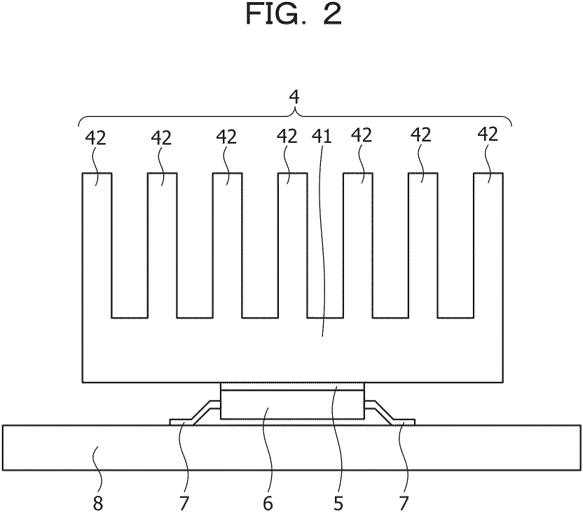

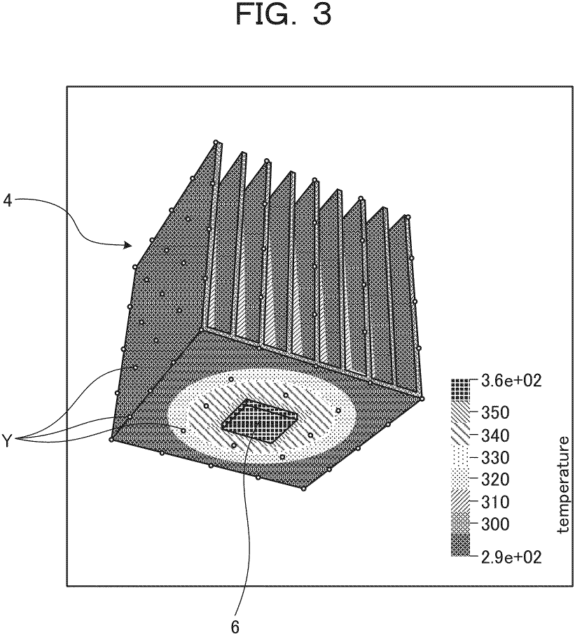

The input information 21a input to the analysis unit 21 and the output information 21b output by the analysis unit 21 will be described with reference to FIGS. 2 and 3.

FIG. 2 is a diagram schematically illustrating an example of the input information 21a. The input information 21a includes shape information of a heat sink 4 to be designed. The heat sink 4 is used to dissipate heat from a heat generation source. In this example, the heat generation source is a central processing unit (CPU) 6 mounted on a substrate 8 with leads 7. A surface of the CPU 6 on the opposite side of the substrate 8 is thermally coupled to the heat sink 4 via a heat conductive material 5.

The heat sink 4 includes a base 41 and a plurality of fins 42. The base 41 is in thermal contact with the CPU 6 via the heat conductive material 5. The heat sink 4 is arranged with respect to the CPU 6 in such a manner that the central portion of the base 41 faces the CPU 6, for example. The plurality of fins 42 each have a base end at a different position on the base 41 and extend at intervals.

The input information 21a includes dimensions of the heat sink 4. The dimensions of the heat sink 4 include the overall dimensions of the heat sink 4 (e.g., envelope shape dimensions), dimensions of each part of the heat sink 4, and the like. Examples of the dimensions of each part of the heat sink 4 include dimensions of the base 41 (width, length, height, etc.), dimensions of the fin 42 (width, length, height, etc.), and the like.

The input information 21a includes temperature information of a heat-generating component, for example, the CPU 6 in this example. Examples of the temperature information include a temperature of the CPU 6 itself, a temperature of a case of the CPU 6 (temperature of a package, etc.), a surrounding temperature (ambient temperature) of the CPU 6, and the like. The input information 21a may include shape information of the CPU 6, and positional information of the CPU 6, for example, information regarding which part of the heat sink 4 the CPU 6 faces to thermally coupled to the heat sink 4 and the like. In addition, the input information 21a may include information related to a fan (not illustrated) provided for the CPU 6, and the like.

FIG. 3 is a diagram schematically illustrating an example of the output information 21b. The output information 21b includes the heat distribution information of the heat sink 4 to be designed. In this example, the heat distribution of the heat sink 4 is illustrated according to a three-dimensional grid set for the heat sink 4. Positions corresponding to intersections of the grid are denoted as positions Y and illustrated. The output information 21b may be information that associates the plurality of positions Y on the heat sink 4 with temperatures.

Returning to FIG. 1, the analysis unit 21 carries out the thermal analysis of the heat sink 4 using the machine learning model MM. The machine learning model MM is a model having been subject to machine learning using training data in advance in such a manner that, when shape information of any heat sink is input, heat distribution information of the heat sink is output. The analysis unit 21 inputs the input information 21a including the shape information of the heat sink 4 to the machine learning model MM, thereby obtaining the output information 21b including the heat distribution information of the heat sink 4 from the machine learning model MM. Note that the shape information and the heat distribution information handled in the machine learning model MM may be data converted into a data format suitable for processing in the machine learning model MM.

The machine learning unit 22 carries out machine learning of the machine learning model MM. Training data to be used for the machine learning of the machine learning model MM is referred to as training data 22a and illustrated. The machine learning unit 22 obtains the training data 22a, and carries out the machine learning of the machine learning model MM based on the obtained training data 22a.

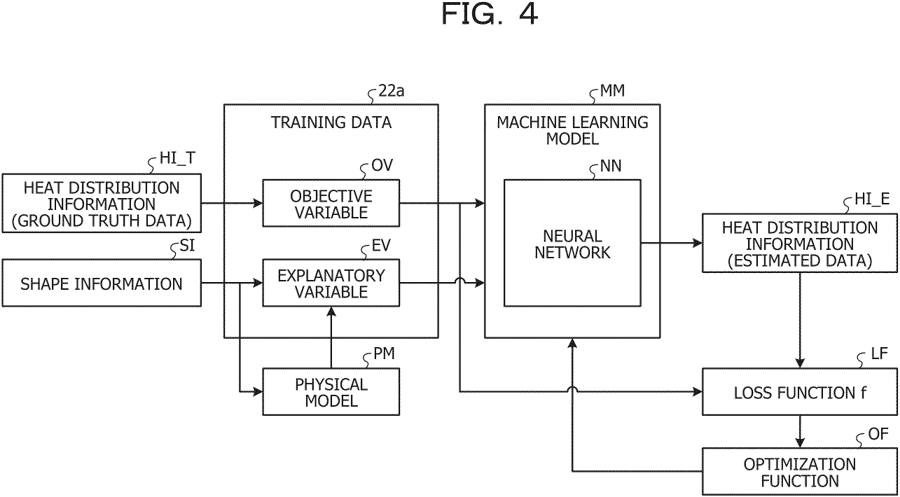

FIG. 4 is a diagram schematically illustrating a machine learning method of the machine learning model MM by the machine learning unit 22. In this example, the machine learning model MM includes a neural network NN. The training data 22a includes an explanatory variable EV and an objective variable OV. The explanatory variable EV will be described first, and then the objective variable OV will be described.

The explanatory variable EV indicates shape information SI of various heat sinks, and includes information similar to the input information 21a of the heat sink 4 described above with reference to FIG. 2. For example, the shape information SI of the heat sink prepared for the training data 22a is input to the machine learning unit 22. The machine learning unit 22 obtains the input shape information SI of the heat sink as an explanatory variable EV.

Moreover, the machine learning unit 22 may obtain fin spacing as an explanatory variable EV. In the example illustrated in FIG. 4, the fin spacing is obtained using a physical model PM of the heat sink. This physical model PM calculates the optimum fin spacing based on physical properties such as heat conduction, heat dissipation, thermal resistance, and the like. For example, the optimum fin spacing is calculated according to the following equation.

$$\text{Fin spacing} \text{= 5} \times {\left(\frac{\text{Fin length}}{\text{Thermal resistance} \times \text{Heat generation amount}}\right)}^{0.25} \qquad \text{(1)}$$

The physical model PM may be stored, for example, in the storage unit 3, so that the machine learning unit 22 of the control unit 2 may use it. The analysis unit 21 of the control unit 2 may also use the physical model PM.

The objective variable OV indicates heat distribution information HI_T of heat sinks related to the explanatory variable EV, and includes information similar to the output information 21b of the heat sink 4 described above with reference to FIG. 3. For example, the heat distribution information HI_T of the heat sink related to the explanatory variable EV described above is input to the machine learning unit 22. The machine learning unit 22 obtains the input heat distribution information HI_T of the heat sink as the objective variable OV.

The objective variable OV indicates ground truth data, and is prepared using actually measured values (experimental results) of heat distribution, results of past heat distribution simulations performed on heat sinks having the same or similar shapes, and the like.

The machine learning unit 22 obtains the training data 22a as described above, and carries out the machine learning of the machine learning model MM based on the obtained training data 22a. The machine learning model MM is trained to output heat distribution information HI_E of a heat sink when shape information SI of the heat sink is input. The heat distribution information HI_E output by the machine learning model MM is estimated data. The machine learning unit 22 trains the machine learning model MM in such a manner that the heat distribution information HI_E (estimated data) output by the machine learning model MM approaches the heat distribution information HI_T (ground truth data) that is the objective variable OV of the training data 22a.

For example, the machine learning unit 22 carries out the machine learning according to a loss function f LF. In the present embodiment, the loss function f LF includes an equation that constrains a temperature relationship of the plurality of positions Y in the heat sink. The loss function f LF is expressed by, for example, the following equation.

$$f = L \left(\hat{Y} , Y\right) + {λ}_{P H Y} {L}_{P H Y} \left(\hat{Y}\right) \qquad \text{(2)}$$

L in the first term on the right side of the equation (2) mentioned above represents a common loss function indicating a difference between the explanatory variable EV and the objective variable OV. λ_{PHY}L_{PHY} in the second term on the right side constitutes an expression that constrains the temperature relationship of the plurality of positions Y in the heat sink. For example, λ_{PHY} represents a constant, and L_{PHY} represents a physics-based loss function that constrains the temperature relationship of the plurality of positions Y in the heat sink 4.

The physics-based loss function L_{PHY} is an expression that describes the heat distribution of the heat sink in line with physics, for example, a relational expression between the enveloping volume and the thermal resistance of the heat sink 4. For example, the physics-based loss function L_{PHY} returns a value according to a magnitude relationship of temperatures at the plurality of positions Y in the heat sink at different distances from a heat source (e.g., CPU 6 in FIG. 2, etc.).

For example, of the plurality of positions Y in the heat sink, a first position Ya and a second position Yb closer to the heat source than the first position Ya will be exemplified. According to the physics, the temperature at the position Ya is lower than the temperature at the position Yb.

When the temperature at the position Ya is lower than the temperature at the position Yb, the physics-based loss function L_{PHY} returns a value smaller than that in the case where the temperature at the position Ya is higher than the temperature at the position Yb. Since the magnitude relationship between the temperature at the position Ya and the temperature at the position Yb is in line with the physics, the physics-based loss function L_{PHY} becomes smaller.

On the other hand, when the temperature at the position Ya is higher than the temperature at the position Yb, the physics-based loss function L_{PHY} returns a value larger than that in the case where the temperature at the position Ya is lower than the temperature at the position Yb. The magnitude relationship between the temperature at the position Ya and the temperature at the position Yb is not in line with the physics, and thus the physics-based loss function L_{PHY} becomes larger.

The physics-based loss function L_{PHY} as described above includes, for example, a rectified linear unit (ReLU) function using a difference between the temperature at the position Ya and the temperature at the position Yb as an argument. An example of such a physics-based loss function L_{PHY} will be set out below.

$${L}_{P H Y} \left(\hat{Y}\right) = R e L U \left(\hat{{Y}_{a}} - \hat{{Y}_{b}}\right) \qquad \text{(3)}$$

Ya with a hat in the equation (3) mentioned above represents a temperature at the position Ya. Yb with a hat represents a temperature at the position Yb. When Ya with a hat is larger than Yb with a hat, the physics-based loss function L_{PHY} returns a value according to the magnitude of the difference. When Ya with a hat is smaller than Yb with a hat, the physics-based loss function L_{PHY} returns zero.

The machine learning unit 22 obtains an optimization function OF that minimizes the loss function f LF, and performs updating (fitting) and the like of parameters of the neural network NN of the machine learning model MM according to the optimization function OF.

The machine learning model MM is trained to minimize the loss function f LF including the physics-based loss function L_{PHY}. The machine learning model MM trained in this manner not only performs high-speed thermal analysis in a similar manner to an existing machine learning model but also functions as a model capable of performing highly accurate thermal analysis in line with the physics. With this machine learning model MM used for the thermal analysis of the heat sink 4, it becomes possible to carry out analysis at high speed and with high accuracy. It becomes possible to derive (design, etc.) appropriate dimensions and the like of the base 41 and the fin 42 capable of obtaining desired heat dissipation characteristics, for example, capable of controlling a device such as the CPU 6 to be at a temperature equal to or lower than a threshold temperature. When the shape information SI of the heat sink 4 includes the fin spacing, it becomes possible to derive appropriate fin spacing as well.

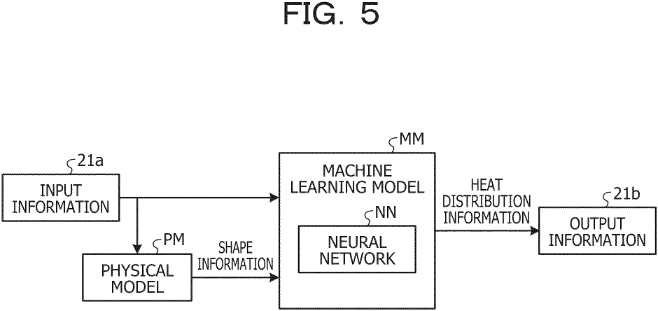

FIG. 5 is a diagram schematically illustrating a thermal analysis method by the analysis unit 21. The input information 21a including the shape information SI of the heat sink 4 to be designed is input to the analysis unit 21, whereby the analysis unit 21 obtains the shape information SI of the heat sink 4. In a similar manner to the machine learning unit 22 described above with reference to FIG. 4, the analysis unit 21 may also obtain, using the physical model PM of the heat sink, the fin spacing as the shape information SI of the heat sink 4. The analysis unit 21 inputs the shape information SI of the heat sink 4 to the machine learning model MM.

In response to the input of the shape information SI of the heat sink 4, the machine learning model MM outputs heat distribution information HI_E of the heat sink 4. The analysis unit 21 obtains the heat distribution information of the heat sink 4 based on the output result of the machine learning model MM. The analysis unit 21 outputs the obtained heat distribution information HI_E of the heat sink 4 as the output information 21b.

For example, as described above, the thermal analysis of the heat sink 4 to be designed may be carried out. With the machine learning model MM used, it becomes possible to carry out the thermal analysis of the heat sink 4 at high speed and with high accuracy.

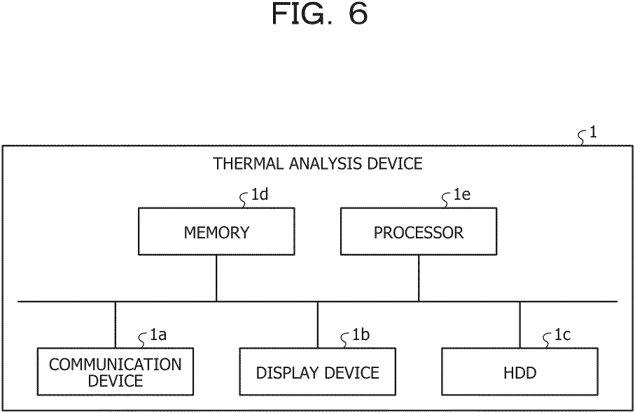

FIG. 6 is a diagram for explaining an exemplary hardware configuration. The thermal analysis device 1 is implemented by a computer including a communication device 1a, a display device 1b, a hard disk drive (HDD) 1c, a memory 1d, and a processor 1e. The communication device 1a, the display device 1b, the HDD 1c, the memory 1d, and the processor 1e are mutually coupled by a bus or the like.

The communication device 1a is a network interface card or the like, and communicates with another server. The display device 1b is a device that displays a correction result or the like, and is, for example, a touch panel, a display, or the like. The HDD 1c stores programs and databases (DBs) for operating the functions illustrated in FIG. 1. The programs are control programs for executing control by the control unit 2, for example, a thermal analysis program for executing thermal analysis by the analysis unit 21, a machine learning program for executing machine learning of the machine learning model MM by the machine learning unit 22, and the like.

The processor 1e reads, from the HDD 1c or the like, a program to load it into the memory 1d, thereby operating a process for implementing each function described with reference to FIG. 1 and the like. For example, this process implements a function similar to that of the control unit 2 included in the thermal analysis device 1. For example, the processor 1e reads the program from the HDD 1c or the like. Then, the processor 1e performs a process for executing processing similar to that of the control unit 2 or the like.

In this manner, the thermal analysis device 1 reads and executes a program to carry out thermal analysis of the heat sink 4. Furthermore, the thermal analysis device 1 may read a program from a recording medium using a medium reading device and execute the read program, thereby implementing functions similar to those of the embodiment described above. Note that the program is not limited to being executed by the thermal analysis device 1. For example, the embodiment may be similarly applied also to a case where another computer or server executes the program, or a case where such a computer and server cooperatively execute the program.

This program may be distributed via a network such as the Internet. Furthermore, this program may be recorded in a computer-readable recording medium such as a hard disk, a flexible disk (FD), a compact disc read only memory (CD-ROM), a magneto-optical disk (MO), a digital versatile disc (DVD), or the like, and may be executed by being read from the recording medium by a computer.

The techniques described above may be explained, for example, as follows. One of the disclosed techniques is a machine learning program. As described with reference to FIGS. 1 to 4, 6, and the like, the machine learning program causes a computer to perform a process including obtaining the training data 22a including shape information SI of a heat sink, which is the explanatory variable EV, and heat distribution information HI_T of the heat sink, which is the objective variable OV, and executing, based on the training data 22a, machine learning of the machine learning model MM according to the loss function f LF including the expression that constrains the temperature relationship of the plurality of positions Y in the heat sink.

According to the machine learning program described above, the machine learning of the machine learning model MM according to the loss function f LF including the expression that constrains the temperature relationship of the plurality of positions Y in the heat sink is carried out. The machine learning model MM trained in this manner not only performs high-speed thermal analysis in a similar manner to an existing machine learning model but also functions as a model capable of performing highly accurate thermal analysis in line with the physics. Accordingly, it becomes possible to carry out the thermal analysis of the heat sink at high speed and with high accuracy.

The acquisition process may obtain the training data 22a further including, as an explanatory variable EV, the fin spacing of the heat sink calculated using the shape information SI of the heat sink, and the execution process may execute the machine learning based on the training data 22a including the fin spacing and the shape information SI of the heat sink as the explanatory variable EV and the heat distribution information HI_T of the heat sink as the objective variable OV. For example, by using the explanatory variable EV, it becomes possible to derive not only the appropriate shape of the heat sink but also the fin spacing that may obtain desired heat dissipation characteristics.

The constraining expression may be the physics-based loss function L_{PHY}, which is a function that describes heat distribution in the heat sink in line with the physics. The physics-based loss function L_{PHY} may be a relational expression between the enveloping volume and the thermal resistance of the heat sink. For example, the physics-based loss function L_{PHY} may return a value according to the magnitude relationship of temperatures at the plurality of positions Y in the heat sink at different distances from the heat source (e.g., CPU 6). The plurality of positions Y includes the first position Ya and the second position Yb closer to the heat source than the first position Ya, and when a temperature at the first position Ya is lower than a temperature at the second position Yb, the physics-based loss function L_{PHY} may return a value smaller than that in the case where the temperature at the first position Ya is higher than the temperature at the second position Yb. The physics-based loss function L_{PHY} may include the ReLU function using a difference between the temperature at the first position Ya and the temperature at the second position Yb as an argument. For example, by using the loss function f LF including such a physics-based loss function L_{PHY}, it becomes possible to obtain the machine learning model MM that may obtain a thermal analysis result in line with the physics.

The machine learning method described with reference to FIGS. 1 to 4, 6, and the like is also one of the disclosed techniques. According to the machine learning method, a computer performs a process including obtaining the training data 22a including shape information SI of a heat sink, which is the explanatory variable EV, and heat distribution information HI_T of the heat sink, which is the objective variable OV, and executing, based on the training data 22a, machine learning of the machine learning model MM according to the loss function f LF including the expression that constrains the temperature relationship of multiple positions in the heat sink. Such a machine learning method also makes it possible to carry out the thermal analysis of the heat sink at high speed and with high accuracy.

The thermal analysis device 1 described with reference to FIGS. 1 to 3, 5, and the like is also one of the disclosed techniques. The thermal analysis device 1 includes the control unit 2 configured to: input the shape information SI of the heat sink 4 to be designed to the machine learning model MM generated by the machine learning according to the loss function f LF including the expression that constrains the temperature relationship of multiple positions in the heat sink using the training data 22a including the shape information SI of the heat sink, which is the explanatory variable EV, and the heat distribution information HI_T of the heat sink, which is the objective variable OV, and obtain heat distribution information HI_E of the heat sink 4 to be designed based on the output result output by the machine learning model MM in response to the input of the shape information SI of the heat sink 4. According to such a thermal analysis device 1, it becomes possible to carry out the thermal analysis of the heat sink at high speed and with high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
obtaining training data that includes shape information of a heat sink that serves as an explanatory variable and heat distribution information of the heat sink that serves as an objective variable; and
executing, based on the training data, machine learning of a machine learning model according to a loss function that includes an expression that constrains a temperature relationship of a plurality of positions in the heat sink.

2. The non-transitory computer-readable recording medium according to claim 1, wherein the process
obtains the training data that further includes, as the explanatory variable, fin spacing of the heat sink calculated by using the shape information of the heat sink, and
executes the machine learning based on the training data that includes the fin spacing and the shape information of the heat sink as the explanatory variable and the heat distribution information of the heat sink as the objective variable.

3. The non-transitory computer-readable recording medium according to claim 1, wherein the expression that constrains the temperature relationship includes a physics-based loss function which is a function that describes heat distribution in the heat sink in line with physics.

4. The non-transitory computer-readable recording medium according to claim 3, wherein the physics-based loss function includes a relational expression between enveloping volume and thermal resistance of the heat sink.

5. The non-transitory computer-readable recording medium according to claim 3, wherein the physics-based loss function returns a value according to a magnitude relationship of temperatures at the plurality of positions in the heat sink at different distances from a heat source.

6. The non-transitory computer-readable recording medium according to claim 5,
wherein the plurality of positions include a first position and a second position closer to the heat source than the first position, and
wherein, when a temperature at the first position is lower than a temperature at the second position, the physics-based loss function returns a value smaller than a value when the temperature at the first position is higher than the temperature at the second position.

7. The non-transitory computer-readable recording medium according to claim 6, wherein the physics-based loss function includes a rectified linear unit (ReLU) function that uses a difference between the temperature at the first position and the temperature at the second position as an argument.

8. A machine learning method for causing a computer to execute a process, the process comprising:
obtaining training data that includes shape information of a heat sink that serves as an explanatory variable and heat distribution information of the heat sink that serves as an objective variable; and
executing, based on the training data, machine learning of a machine learning model according to a loss function that includes an expression that constrains a temperature relationship of a plurality of positions in the heat sink.

9. The machine learning method according to claim 8, wherein the process
obtains the training data that further includes, as the explanatory variable, fin spacing of the heat sink calculated by using the shape information of the heat sink, and
executes the machine learning based on the training data that includes the fin spacing and the shape information of the heat sink as the explanatory variable and the heat distribution information of the heat sink as the objective variable.

10. The machine learning method according to claim 8, wherein the expression that constrains the temperature relationship includes a physics-based loss function which is a function that describes heat distribution in the heat sink in line with physics.

11. The machine learning method according to claim 10, wherein the physics-based loss function includes a relational expression between enveloping volume and thermal resistance of the heat sink.

12. The machine learning method according to claim 10, wherein the physics-based loss function returns a value according to a magnitude relationship of temperatures at the plurality of positions in the heat sink at different distances from a heat source.

13. The machine learning method according to claim 12,
wherein the plurality of positions include a first position and a second position closer to the heat source than the first position, and
wherein, when a temperature at the first position is lower than a temperature at the second position, the physics-based loss function returns a value smaller than a value when the temperature at the first position is higher than the temperature at the second position.

14. The machine learning method according to claim 13, wherein the physics-based loss function includes a rectified linear unit (ReLU) function that uses a difference between the temperature at the first position and the temperature at the second position as an argument.

15. A thermal analysis device comprising:
a memory; and
a processor coupled to the memory and configured to:
input shape information of a heat sink to be designed to a machine learning model generated by machine learning according to a loss function that includes an expression that constrains a temperature relationship of a plurality of positions in a heat sink by using training data that includes shape information of the heat sink that serves as an explanatory variable and heat distribution information of the heat sink that serves as an objective variable; and
obtain heat distribution information of the heat sink to be designed, based on an output result output by the machine learning model in response to the input of the shape information of the heat sink.

16. The thermal analysis device according to claim 15, wherein the processor is configured to
obtain fin spacing of the heat sink calculated by using the shape information of the heat sink, and
input the fin spacing and the shape information of the heat sink to the machine learning model.

17. The thermal analysis device according to claim 15, wherein the expression that constrains the temperature relationship includes a physics-based loss function which is a function that describes heat distribution in the heat sink in line with physics.

18. The thermal analysis device according to claim 17, wherein the physics-based loss function includes a relational expression between enveloping volume and thermal resistance of the heat sink.

19. The thermal analysis device according to claim 17, wherein the physics-based loss function returns a value according to a magnitude relationship of temperatures at the plurality of positions in the heat sink at different distances from a heat source.

20. The thermal analysis device according to claim 19,
wherein the plurality of positions include a first position and a second position closer to the heat source than the first position, and
wherein, when a temperature at the first position is lower than a temperature at the second position, the physics-based loss function returns a value smaller than a value when the temperature at the first position is higher than the temperature at the second position.
